(19) United States
(12) Patent Application Publication
(10) Pub. No.: US 2017/0107706 A1
(43) Pub. Date: Apr. 20, 2017

(54) Water Pump With Safe Cross Connection

(71) Applicants: Sherman Robert Schwartz, Valparaiso, IN (US); Charles Earl Tarpley, Chesterton, IN (US)

(72) Inventors: Sherman Robert Schwartz, Valparaiso, IN (US); Charles Earl Tarpley, Chesterton, IN (US)

(21) Appl. No.: 14/884,928

(22) Filed: Oct. 16, 2015

(51) Int. Cl. E03C 1/10; F16K 15/00; F16K 31/18; E03B 7/07

(52) U.S. Cl. CPC E03C 1/102; E03B 7/077; F16K 15/00; F16K 31/18

(57) ABSTRACT

A unique piping arrangement of a water pump system is designed to prevent backflow of non-potable liquid into a potable water source thereby complying with plumbing codes to provide a safe cross connection. These codes are required when a water ejector uses pressurized potable water as an energy source. When the water ejector valve is open due to a high sump level and when the potable water pressure drops below atmospheric, the non-potable liquid can be siphoned into the potable water source thereby causing contamination, a significant unsafe health hazard to consumers. The present invention complies with plumbing codes by creating the required vertical air gap from the potable water source down to the non-potable liquid in the discharge piping as well as the inlet piping, the sources of contamination. In the piping arrangement are vents and drains to create the required air gap and transparent piping to provide required inspection and verification of proper operation. The water ejector is commonly used as a back-up to a traditional electric sump pump. The invention provides simplicity to maximize system reliability. Two kits of commonly used applications, a residential full basement back-up water ejector sump pump and a residential crawlspace back-up water ejector sump pump, are described.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

### DISCLOSED PRIOR ART—U.S. PATENTS

U.S. Pat. No. 8,327,873

U.S. Pat. No. 6,527,518

U.S. Pat. No. 5,613,835

U.S. Pat. No. 5,302,088

U.S. Pat. No. 4,552,512

U.S. Pat. No. 4,482,299

U.S. Pat. No. 4,422,829

### DISCLOSED PRIOR ART—U.S. PATENT APPLICATIONS

2005 020792

### FIELD OF CLASSIFICATION SEARCH

00010 417/26, 417/31, 53, 199.2, 137/337, 236/12.1v

### FIELD OF THE INVENTION

The present invention relates to water powered devices, including pumps and the methods and devices that prevent backflow of non-potable liquid into a potable water source thereby complying with cross connection plumbing codes while using potable water as an energy source to pump non-potable liquid.

Statement of the Problems Solved by the Invention

A sump, meaning a pit or reservoir serving as a receptacle for liquids typically at the lowest point in a drainage system, may require periodic level reduction. Reducing the sump contents frequently requires transferring the liquid to a higher elevation. Several means exist to accomplish this mission, including bucket brigades, water wheels, electric drive pumps, water ejectors, etc. The present invention provides a solution to this general task of transferring these sump liquids to a higher level with a potable water powered ejector requiring very little mechanical intricacies which significantly improves much needed reliability. Furthermore, it also importantly solves an inherent problem of cross contamination of the energy supplying potable water and the non-potable pumped liquid. The foregoing is a widespread example and practical application of the invention and how it solves the cross contamination problem.

The example is the case of a residential, public or commercial building's full basement sump pump. Ground water commonly invades a basement sump. Reducing the sump contents is necessary to prevent an overflow flood from occurring. An overflow of a basement sump can destroy valuable belongings, floor coverings, walls, furniture and product in storage. In addition, the flood can cause mold, a significant health hazard, as well as other potential hazards, including slips and falls.

Electric drive sump pumps are a standard appliance in the above example due to the low cost of the equipment and the low operating cost compared to other available means in the prior art. The electric pump, when sized and installed properly, is energy efficient, works quickly and is generally reliable. It does; however, have limitations. A major limitation is that electrical power outages stop their operation. Power outages: blackouts, brownouts, transient faults and cascading failures are caused by lightning strikes, strong winds, accidental severing of buried and overhead lines and excessive power demand. Coincidentally power failures are frequently accompanied by storms, which are also often attended by rain that feeds excess ground water to the sump. So just when the ground water is flowing into the basement sump the related electric power—sump pump failure may result in an unwanted flood. Power failures may only be seconds in duration or last for days. It is not uncommon for power outages to occur on a monthly frequency, depending on the locale. A further electric pump limitation is the failure of the pump system components, including the motor, the motor bearings, the float actuator, the impeller, the housing and the check valve. The life of a sump pump is generally accepted to be 10 years for average use, but can be as little as a yearly expense when use in or near a flood plane. One power outage or pump component failure and the ensuing flood can cost several thousands of dollars in damage.

Given the considerable expense of an electrical drive sump pump failure, many have employed a back-up sump pump system. Yet, each of these back-up systems has their inherent failings.

A primary failing of any back-up system is its reliability. In practice the back-up is idle for long periods of time. When it is called upon, it functions for a relatively short time until the primary system returns. This infrequent use necessitates that the system is usually operated at the very beginning of the back-up's life.

Reliability engineering widely uses a bathtub curve to characterize failure rates on systems particularly mechanical ones like a back-up sump pump. The name bathtub curve is derived from the cross-sectional shape of a bathtub: steep sides and a flat bottom. The vertical axis of the curve is failure rate while the horizontal axis is time. As time starts the failure rate is high. These are called early failures. The failure rate curve then drops down with advancing time to a constant low level called random failures. After a long interval of time the failure rate rises due to wear-out failures.

The back-up, therefore operating at its very beginning of its life or at the shortest time has a naturally high rate of failure and the least reliable. To further increase its failure rate is the complexity of the system. For example: A straight pipe is inherently more reliable than a straight pipe which included a check valve. During the long time immersed in water, water sediment, a common contaminate, will take a long time to fill a straight pipe but a short time to invade the small openings in the structure of a check valve's seat and fulcrum. Pilot valves, diaphragms, springs, needle valves etc., all susceptible to sediment, corrosion, manufacturing defects will increase the failure rate and therefore reduce reliability. It is ironic that back-up systems are installed to overcome a lack of reliability in a primary system only to be plagued by their own lack of reliability. While a case can be made that one component is more robust than another for the same task, it may be also be postulated that the most reliable system has the fewest components.

Prior Art

One common prior art solution is a battery back-up electric sump pump. The battery back-up electric system is connected to the local electrical system to charge the storage batteries as necessary. The battery back-up electric system using direct current (DC) electrical power from the storage batteries to drive a separate, specially designed electric sump pump that's motor and controls will accept DC battery power. A separate float controls the pump operation within the sump but at a higher elevation than the primary system.

The battery back-up electric sump pump has limitations. The capacity of the batteries is typically 4 hours, not long enough for a long outage. The battery back-up systems are commonly four times the expense of an ordinary electric sump pump. In addition, the battery requires costly annual renewal, maintenance and inspection. The required maintenance of changing battery acid can also be a dangerous task.

An alternative prior art solution is a water ejector. A water ejector is a type of pump that uses the “Venturi-effect” of a converging-diverging nozzle to convert the pressure energy of a motive fluid to velocity energy which creates a low pressure zone that draws in and entrains a suction fluid, in this case the sump contents. After passing through the throat of the ejector, the mixed fluid expands and the velocity is reduced which results in recompressing the mixed fluids by converting velocity energy back into pressure energy. The motive fluid, which supplies the energy, in this case is an available municipal potable (safe for human consumption) water supply from a water utility. The value of this device as a back-up is that the utilities potable water system does not depend on electrical power as the water systems have elevated, high volume water towers and reservoirs that rely on gravity and provide reliable supply for customer's consumption, irrigation, home use, firefighting and other uses. In addition, most water utilities also have diesel electric generators to maintain water processing and delivery during power outages. Water ejectors also have an advantage in that they have no moving parts with the exception of the water valve, float mechanism and check valve. This improves reliability and reduces the initial cost, thereby being an improvement over an electric sump pump.

Water ejectors have unfortunate limitations. The water valve, check valve and float mechanism can fail, but not as common as a more mechanical fashion of pumping. In addition, since the normal situation is that the potable water valve is surrounded by non-potable liquid there is a condition called “Cross Connection”. When the potable water supply is lost there is the possibility of cross contamination wherein the non potable liquid is drawn into the potable water pipes. Water supply loss can occur when a water line is shut down for repair or renovation anywhere in the locality that affects the pressure on the energy supplying line of the Venturi-effect line of this solution. When the water supply is off, the water pressure drops to zero and due to the piping elevation difference some parts of the system will result in a negative pressure (a suction or siphon condition). In the case of the water ejector, the potable water supply valve will open when the sump liquid level activates the float. Under the negative pressure (suction) non-potable sump liquid can be drawn into the potable water supply contaminating the safe water supply for the customer and in some instances an entire neighborhood. While actual pipe longevity is high at over 100 years, cold weather freezing and thawing can cause water pipe leakage. The frequency of a loss of supply is extremely rare. It, however, can and does occur, which has resulted in strict compliance regulations that follow.

In order to prevent this occurrence governmental agencies such as the Indiana Department of Environmental Management and the Federal Environmental Protection Agency have regulations for the six basic types of devices that can be used to make safe cross-connections: air gaps, barometric loops, vacuum breakers—both atmospheric and pressure type, double check with intermediate atmospheric vent, double check valve assemblies, and reduced pressure principle devices. The barometric loop requires a 35 foot vertical pipe loop to prevent back siphoning; a costly and difficult installation problem. The vacuum breakers, double check valves and reduced pressure principle are all mechanical devices with springs, resilient seals and seats; all subject to breakage, being fouled, being blocked open or closed and wearing out. The air gap has no moving parts to fail. All others are subject to rigorous and costly periodic testing.

Regarding the air-gap requirement the following is defined by the Indiana Department of Environmental Management in the 2013 Edition Bulletin PWS 1, December 1987, Revised February 1996, Reprinted June 1997, Revised 2001 & 2009, & 2013, titled Cross Connection Control & Backflow Prevention Manual.
“Appendix C: Additional and Expanded Definitions Air-gap separation—the unobstructed vertical distance through the free atmosphere between the lowest opening from any pipe or faucet supplying water to a tank, plumbing fixture or other device and the flood level rim of the receptacle. An “approved air-gap separation” shall be at least double the inside diameter of the supply pipe or six inches, whichever is less as measured vertically above the top rim of the vessel; in no case shall the gap be less than one inch. In cases where: a side wall, rib, or similar obstruction is spaced closer than three diameters from the piping affecting the air gap; or (B) two intersecting walls are located closer than four pipe diameters from the piping affecting the air gap; a minimum of three times the diameter of the discharge pipe or six inches, whichever is less, is required above the maximum recorded flood level or above the flood level rim of the receiving vessel, whichever is higher.”

Furthermore, in the same document regarding an air gap: Sec. 8 (b) “To ensure that each cross connection control device required by this rule is in working order, the customer shall have each device inspected or tested by a cross connection control device inspector at the time of construction or installation, and at the following intervals, in the following manner: (1) Air gaps shall be inspected at intervals not exceeding one (1) year to ensure that they continue to meet the requirements of section 7 of this rule.”

The United States Environmental Protection Agency has published a Cross-Connection Control Manual From the Office of Water, Office of Ground Water and Drinking Water, First Printing 1973, Reprinted 1974, 1975, Revised 1989, Reprinted 1995, Technical Corrections 2003. Similar constraints are found that require a 6-inch gap and comprehensive inspection.

The patented and patented application prior art is compared to the proposed invention based on 1. greater reliability of fewer, less restrictive and complex components and 2. the presence of means to assure a safe cross connection that protects the public's health.

Numerous inventions address the use of a water powered sump pump as a backup to an electrical powered sump pump.

One of the first was Buchanan in U.S. Pat. No. 4,422,829 on Dec. 27, 1983 with “Sump drain system” claimed a drain system “comprising a first energizable by said electrical power, and a second pump energizable by said municipal water.” The system provides a minimum of moving parts and is reasonably reliable except for the need for a mechanical check valve. The system, however, did not address or prevent the concern of backflow and therefore, provide a safe cross connection. This was due to the ejector being below the discharge level and therefore, “continuously flooded” and without a preventative means to avoid sump liquid invading the potable water supply during a loss of pressure in the main water supply.

Eulass in U.S. Pat. No. 4,482,299 granted on Nov. 13, 1984 with “Water powered sump pump” proposed a more efficient water ejector. The design was simplified by submerging the entire pump and valve in the sump pit. The design includes a check valve and a more complex pilot valve arrangement. Once again backflow was not addressed and the design lacks a safe cross connection.

Gallup, et al. in U.S. Pat. No. 4,552,512 approved on Nov. 32, 1985 with “Standby water-powered basement sump pump” provides a unit with complete safe cross connection in that potable water powers a rotary sliding vane pump which then through the connecting shaft pumps the sump water from the basement. The drive potable water never comes in contact with the contaminated sump water. The rotary sliding vane pump is, however, problematic from a reliability stand point. To provide adequate volume the vanes must slide tightly in the slots provided. Being immersed in the potable and non-potable sump water the sediment and other corrosion product would quickly enter these tight clearances freezing the operation. It's reliability especially as a back-up would be poor.

Gronski, et al. in U.S. Pat. No. 5,302,088 official on Apr. 12, 1994 titled “Water powered sump pump” proposes a more sophisticated water valve operating system. In this the float activates a pilot line to a dual chamber wherein a spring-loaded diaphragm valve opens to drive the water pump. The reliability of this system is lessened by the several components and close clearances exposed to the water system. Backflow

Tyner in U.S. Pat. No. 5,613,835 on Mar. 25, 1997 with “Flow control apparatus for a water powered sump pump” proposes a similar apparatus as Gronski with a unique inlet valve arrangement. In place of the pilot line there is an orifice which connects the two chambers. The float mechanism controls the orifice and the spring-loaded diaphragm valve opens to drive the water pump. Once again, the reliability of this system is lessened by the several components and close clearances exposed to the water system. Backflow was again not addressed and the design lacks a safe cross connection.

Ostrowski in U.S. Pat. No. 6,527,518 on Mar. 4, 2003 proposes “Water-powered sump pump”, a water powered piston that is articulated lifting the sump liquid to a discharge by several check valves in the entry and discharge piping. The mechanical complexity of this invention is considerable with numerous moving parts and fraught with vulnerable resilient elements such as O-rings and diaphragms. The reliability of this system is considered to be very poor. Backflow was again not addressed and the design lacks a safe cross connection.

Acker in U.S. Pat. No. 8,327,873 on Dec. 11, 2012 offered “Temperature back flow control valve” a device to prevent backflow. In this case the reason to prevent backflow is to prevent cold water from entering a hot water system. A temperature sensor activates a controller which advances a plug to a seat. Acker's work is referenced only to highlight the robustness and complexity that is common to the efforts to prevent backflow.

Bonifacio, et al. in United States Patent Application 2005/0207902 submitted on Sep. 22, 2005 with “Machine for removing sump pit water and process for making same” is perhaps the closest concept to the proposed invention.

The Bonifacio claims for the “machine” and the “process” that are the same are:
the ejector being at the same elevation as the discharge,
the ejector having an atmospheric vent.

The Bonifacio claims that differ for the “machine” and the “process” include:
an adjustable timing control allowing the pump an independent discharge line,
sump ejector with a atmospheric vent preventing backflow,
sump ejector with an independent suction line,
sump ejector with an internal check valve,
sump ejector with integral backflow prevention device.

The claim that the adjustable timing control “allows” an independent discharge does not make any sense and is not explained. The discharge will be independent regardless of the timing of the valve opening. In addition, the value or purpose of the adjustable timing control is not clear or explained (beyond allowing an independent discharge). Adjustable timing control generally is used in cases like this for water hammer avoidance. There is no apparent need for adjustable timing control in this application.

The claim “preventing backflow” claim associated with “sump ejector with a atmospheric vent” is an vacant claim. Preventing Backflow is defined by the Federal Environmental Agency (EPA) and various state agencies as described above. The most stringent and universally accepted standard is the 6″ vertical air gap. The subject prior art, based on the figures provided, the check valve in the vertical suction pipe and the common piping sizes used (typically 1-½″), clearly has less than 6″ vertical air gap.

The claim for an independent suction line is confusing when viewed in association with the subsequent claim of an internal check valve which is in the suction line. The term independent means autonomous, self-governing, self-regulating, etc. The check valve in the suction line restricts the flow of liquid to one direction and is the main reason that the device as a whole does not prevent backflow as defined previously. The check valve holds the liquid in the suction line at an elevation approximately 1″ from the water supply and certainly less than the mandated EPA 6″ vertical air gap.

The last claim for use of an integral backflow prevention device I believe refers to a check valve in the pilot tube. This check valve on its face is designed to prevent a flow of sump liquid from flowing into the potable water supply but again does not approach the EPA standards for backflow prevention.

There is a significant difference in the Bonifacio device regarding the reliability referred to in the Statement of the Problems Solved by the Invention section. The suction check valve, the adjustable timing control provides several close clearance components such as the needle valve, the check valve and the tube. Along with these, there are several moving parts in the float valve assembly that invite early failure and significantly reduce reliability over the proposed invention.

In light of the above problems there is a need for an improved water ejector system that is an effective and reliable back-up sump pump system and meets the cross connection safety requirements of government agencies. It is offered, therefore, that the unique and useful claims of the proposed invention differ significantly from the prior art.

### SUMMARY OF THE INVENTION

The subject invention is a unique piping arrangement of the inlet and discharge piping of a back-up water ejector sump pump system that creates a safe cross connection. The subject invention is also unique in featuring a minimum of mechanical intricacies to maximize reliability. The safe cross connection is an air gap that eliminates the possibility of non-potable liquid being siphoned into the potable water source through the water valve when the potable water supply is lost. The piping arrangement provides an air passage that allows the non potable liquid to flow by force of gravity to a point lower than the potable water valve thereby creating an air gap and air passageway. The invention satisfies certain key logistical features for safe cross connection in accordance with required ordinances. First, the water ejector water valve must be installed at least six inches above the grade or local flood level. Second, there must be an atmospheric vent on the discharge piping to break a vacuum and allow non-potable liquid to flow downward at least six inches below the water valve in the discharge and inlet direction. Third, there must be a drain in the inlet piping to draw down non-potable liquid to at least the required six inches below the water valve. Fourth, in the key locations the piping is fabricated of transparent material so the system may be visually inspected so as to assure its proper and required operation.

In operation, the water ejector upon activation by the float mechanism, lifts the non-potable sump liquid the length of the inlet/drain pipe and then pulls the non-potable liquid through the ejector into the discharge pipe and then into a receiving vessel or the environment at or above grade. As the water ejector sufficiently draws the sump level down, the float mechanism shuts off the water ejector valve. The vent to atmosphere in the discharge pipe then allows the non-potable water to drain leaving an air passage in the discharge pipe up to the potable water valve. The inlet i drainpipe then allows the non-potable liquid on the ejector inlet to drain downward from and below the water ejector valve. The key effect is that the non-potable liquid immediately drains away from the water source valve through the discharge and inlet/drain pipe to the minimum required vertical air-gap height leaving air in place of the non-potable liquid. Pipe made of transparent material is used in the discharge and inlet piping to provide for visual inspection and a determination that an air gap has been created and sustained.

The invention features minimum mechanical intricacies. The only mechanical device required is the float mechanism which activates the potable water ejector inlet valve. The float part is situated on the sump liquid surface. It is constructed of a variety of sturdy materials for example metal or plastic hollow balls or other shape or a foam shape. The float relies on dependable gravity to function. The float actuates a water valve which is spring loaded. When the weight of the float is released from the spring by the rising sump liquid, the potable water valve opens. When the sump water level recedes the weight of the float overcomes the spring and the valve closes. This feature is of considerable importance not just to add reliability to the operation of the system as a back-up but also to assure a safe cross connection.

### BRIEF DESCRIPTION OF THE DRAWINGS

In the drawings, the sizes and relative positions of the elements in the drawings are not necessarily to scale.

FIG. 1 is a front elevation view of a General Embodiment of a unique piping arrangement of the inlet and discharge piping of a back-up water ejector sump pump system.

FIG. 2 is a front elevation view of an Energy Efficiency Embodiment of the unique piping arrangement of a back-up water ejector sump pump system invention with part of the inlet/drain separated into an inlet, a riser and a drain pipe.

FIG. 3 is an isometric view of a first specific preferred embodiment of the invention: a Residential Full Basement Back-Up Water Ejector Sump Pump.

FIG. 4 illustrates a kit for a Residential Full Basement Back-Up Water Ejector Sump Pump.

FIG. 5 is an isometric view of a second specific preferred embodiment of the invention: a Residential Crawlspace Back-Up Water Ejector Sump Pump.

FIG. 6 illustrates a kit for a Residential Crawlspace Back-Up Water Ejector Sump Pump.

### DETAILED DESCRIPTION OF THE INVENTION

There are several embodiments of the invention each accommodating the local installation geometry, the efficiency of the process and space limitations.

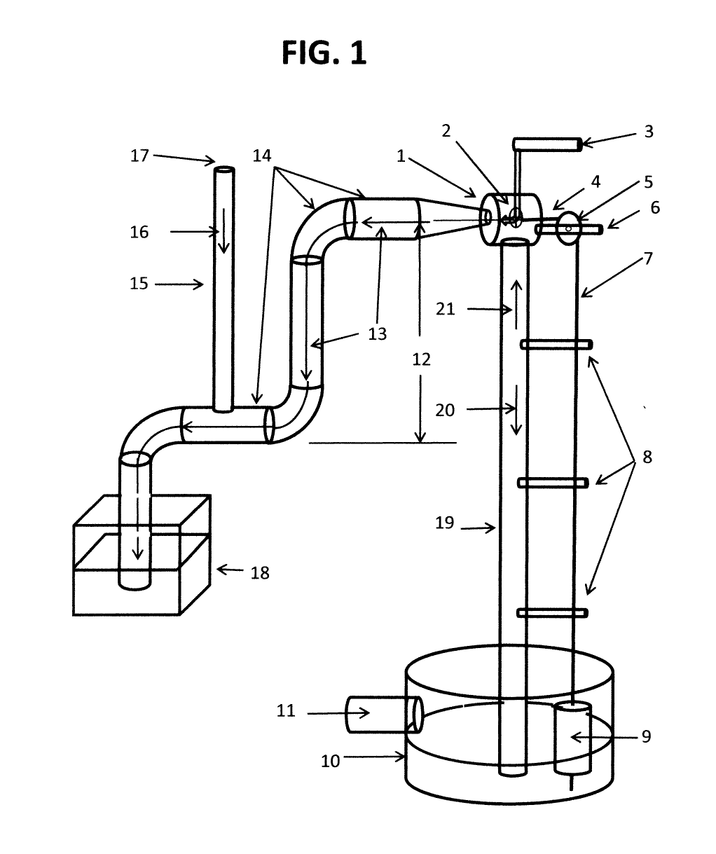

A General Embodiment of the back-up sump pump is a water ejector with a safe cross connection as shown in FIG. 1. The system comprises of a water ejector 1 with an internal potable water valve 2 fed with potable water through the potable water inlet pipe 3.

In FIG. 1, the General Embodiment, the water ejector is shown in a horizontal orientation. In fact, the water ejector can be oriented at any angle, horizontally or vertically with the outlet pointed downward or upward. The preferred orientation of the water ejector is determined by the specific dimensional limitations of the installation site, the minimum height required by the plumbing code, and the complexity of the water ejector valve actuator. The primary design objective of the orientation is to enable a safe cross connection made available by the ability to totally drain the non-potable liquid by gravity to below the potable water valve to the minimum height required by plumbing code.

In the General Embodiment shown in FIG. 1, the potable water valve is opened or dosed by a horizontal actuator rod 4 which is subsequently driven through an actuator directional changer 5 and subsequently driven by a vertical actuator rod 7 and finally driven by an actuator float 9 that is driven by the height of the non-potable liquid in the sump vessel 10 fed by the sump inlet 11. The actuator directional changer is held up by a directional changer support 6. The vertical actuator rod is supported in several locations by guides 8 which are fastened to the inlet pipe 19 by hose clamps.

The water ejector is connected to an inlet pipe 19 that serves as an inlet and a drain. When the water ejector valve is actuated, the non-potable liquid is drawn up the pipe and the pipe acts as an inlet pipe. The direction of flow in this case 21 is shown in FIG. 1. When the water ejector operation stops due to the water ejector valve closing or a loss of water supply, the non-potable liquid is drained down the inlet pipe and the inlet pipe acts as a drainpipe. The direction of flow in this case 20 is shown in FIG. 1.

As shown in FIG. 1, the minimum air gap height 12 of 6 inches is required for a safe cross connection.

The discharge piping 13 is connected to the water ejector. The piping extends horizontally and downward to dimensionally achieve the minimum height drop. After the minimum height is achieved, a non-potable liquid discharge vent pipe 15 is attached to the discharge pipe, extending upward above the water ejector to a level which prevents non-potable liquid from escaping the vent pipe during active ejector operation. When the water ejector valve is actuated, the non-potable liquid is directed into and down the discharge pipe. The direction of flow in this case 13 is shown in FIG. 1.When the water ejector operation stops due to the water ejector valve closing or a loss of water supply, the open end of the non-potable liquid discharge vent pipe 17 admits air, allowing the liquid in the vent and the discharge pipe to drain completely from the discharge piping specifically from the potable water ejector valve to the level of the non-potable liquid receiving vessel 18.

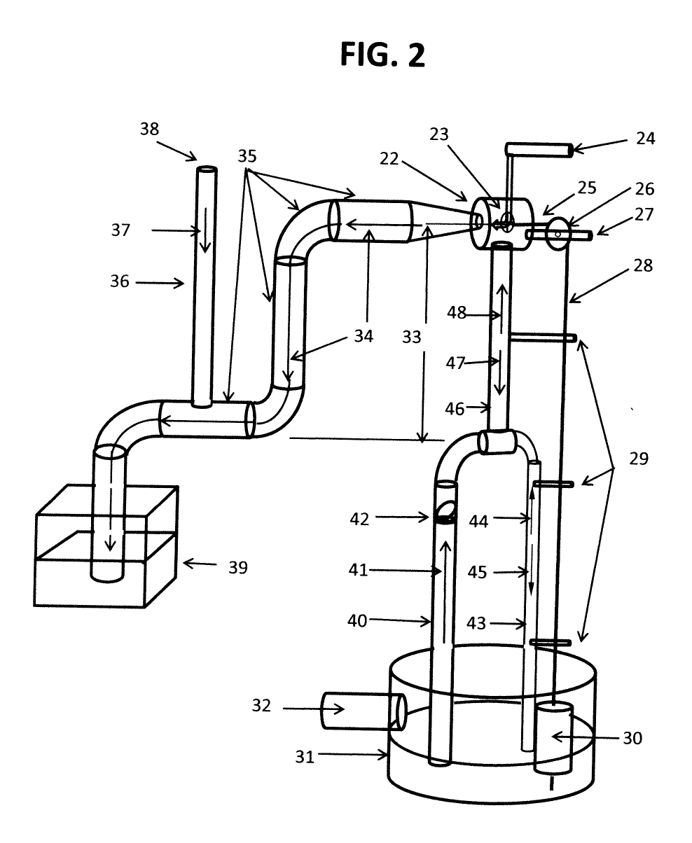

Shown in FIG. 2 is an Energy Efficiency Embodiment of the back-up water ejector sump pump invention. The following components of this embodiment, are identical to the General Embodiment Water Ejector 1, Potable Water Ejector Inlet Valve 2, Potable Water Inlet Pipe 3, Water Ejector Valve Horizontal Actuator Rod 4, Water Ejector Valve Actuator Directional Changer 5, Water Ejector Valve Actuator Directional Changer Support 6, Water Ejector Valve Vertical Actuator Rod 7, Water Ejector Valve Vertical Actuator Rod Supports 8, Water Ejector Valve Actuator Float 9, Sump Vessel with Non-Potable Liquid 10, Non-Potable Liquid Inlet into Sump 11, Plumbing Code Air Gap Distance—“6 inches or greater” 12, Non-Potable Liquid Discharge Piping 13, Non-Potable Liquid Discharge Piping Flow Direction—Ejector On or Off 14, Non-Potable Liquid Discharge Vent Piping 15, Air Flow Direction—Ejector Off 16, Discharge Vent Piping—Open to Atmosphere 17, Non-Potable Liquid Receiving Vessel 18.

The Energy Efficiency Embodiment of the invention in FIG. 2 differs in that the inlet/drainpipe 19 of FIG. 1 is replaced with three pipes. In FIG. 2 the first is a non-potable liquid riser inlet pipe 19. The riser inlet pipe's diameter is designed to accommodate the full flow of the water ejector. The riser also has a check valve 21 and therefore retains non-potable sump liquid. The second is the non-potable liquid ejector inlet pipe 24 whose diameter is also designed to accommodate the full flow of the water ejector. The third is the non-potable liquid drainpipe 22. The drainpipe is typically smaller one quarter to one third the diameter if the riser or inlet pipe.

Since the drainpipe has no check valve the riser pipe non-potable liquid ascends to the top of the drainpipe and no farther. In practice, prior to active operation, the riser inlet pipe is full of non-potable liquid and the inlet and drain are full of air.

When the water ejector valve is actuated, the non-potable liquid is drawn up the drainpipe 23 and joins the waiting riser inlet pipe's non-potable liquid 20 at the drainpipe's juncture. The combination then flows up into and through the inlet pipe 26. The arrangement of a check valve on the riser inlet and the smaller diameter drainpipe has three efficiency benefits. First, there is a lower energy requirement to draw a lesser amount of liquid vertically through the smaller drainpipe. Second, the check valve retains liquid so that a reduced liquid volume is returned to the sump, which would otherwise need to be pumped again. Third, the smaller volume drawn up in the smaller diameter drainpipe is a faster start up when the water ejector is reactivated.

When the water ejector operation stops due to the water ejector valve closing or a loss of water supply, the air gap created on the discharge allows non-potable liquid to flow down the inlet pipe 25 and then continue to flow down the drain pipe 22 creating air gap in the inlet pipe of the minimum height for a safe cross connection.

As before a transparent pipe is used as the inlet pipe and the discharge pipe. This provides for a visual inspection and the conclusion that an air gap has been created.

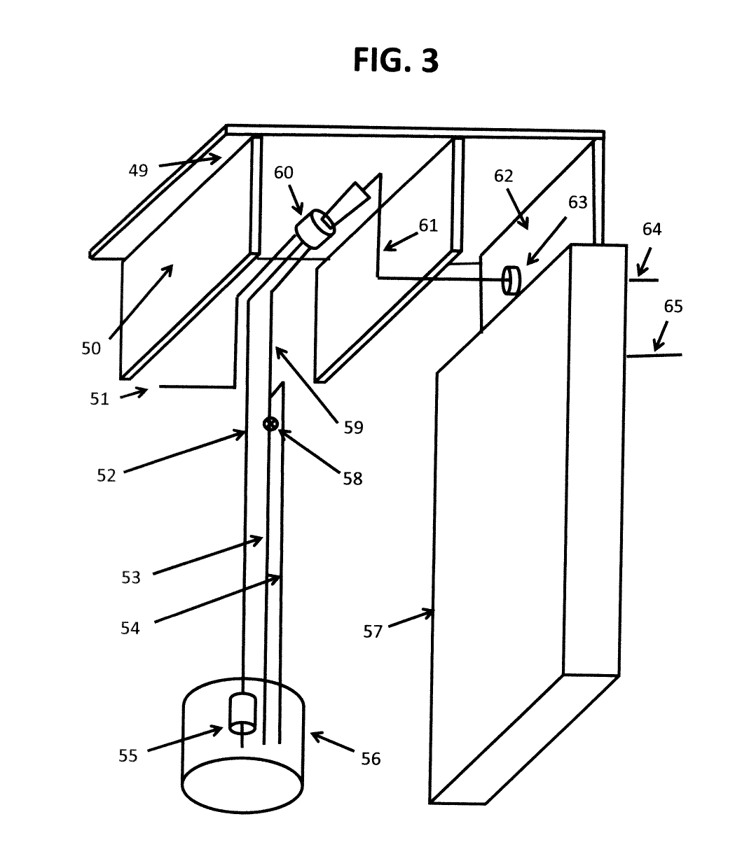

FIG. 3 is a Residential Full Basement Back-Up Water Ejector Sump Pump Embodiment. For this embodiment the vertical limit is the basement ceiling 1. An additional dimensional limit is the floor joists 2 in that the floor joists typically rest on the concrete foundation 9. The limitation is that the minimum height air gap must be achieved by the discharge pipe 13 by passing horizontally and downward vertically from the water ejector to a hole 14 in the exterior floor joist 15 to allow complete draining of the non-potable liquid upon the deactivation of the water ejector. The water ejector has a finite thickness, as does the discharge pipe diameter. Typically floor joists are 7.25 to 11.25 inches in vertical height so the six-inch ordinance requirement is possible if the piping and equipment are designed properly. An additional limitation is the vertical distance between the discharge pipe's 16 exit from the hole in the exterior floor joist and the exterior grade (flood level) 17.

The remaining piping arrangement follows the same configuration and operation of the General Embodiment or the Energy Efficiency Embodiment. The potable water supply 3 is routed to the water inlet valve in the water ejector 12. The water ejector float actuator rod 4 extends downward to the actuator float 7 in the sump vessel 8 recessed in the basement floor. The non-potable liquid inlet piping comprises the non-potable liquid riser inlet pipe 5, with a check valve 10, the non-potable liquid drainpipe 6, and the non potable liquid ejector inlet pipe 11.

As before a transparent pipe is used as the inlet pipe and the discharge pipe. This provides for a visual inspection and the conclusion that an air gap has been created.

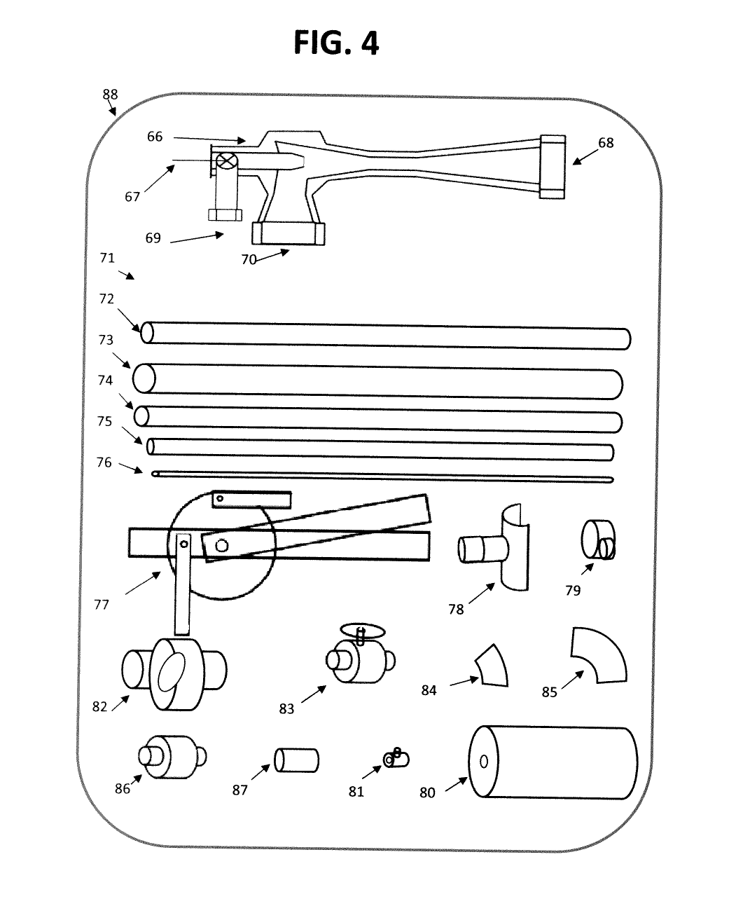

FIG. 4 shows a kit for a Residential Full Basement Back-Up Water Ejector Sump Pump 23. The kit contents are the water ejector 1 with a potable water actuator rod 2, a discharge port 3, a potable water inlet 4 and an inlet port 5. The piping needs consist of the transparent discharge piping 6, typically clear PVC plastic pipe 1½ inches in nominal inside diameter, the transparent inlet piping 7, typically clear PVC plastic pipe 1¼ inches in nominal inside diameter, the opaque discharge piping 8, typically opaque PVC plastic pipe 1½ inches in nominal inside diameter, the opaque inlet and riser piping 9, typically opaque PVC plastic pipe 1¼ inches in nominal Inside diameter, the opaque drain piping 10, typically opaque PVC plastic pipe ¾ inches in nominal inside diameter. One 10-foot length of each is provided. Also shown is an actuator rod 11, typically ¼ inches in diameter. Three 4-foot lengths with connectors are provided. An actuator rod directional changer 12 is provided which attaches to the water ejector body for support and proper alignment. The actuator rod and the drainpipe are provided lateral support by guides 13 held to the riser pipe by 1½ inch hose clamps 14. The actuator float 22 slides onto the bottom of the actuator rod and is held in place by 2 float actuator retainer rings 21. Various necessary pipe fittings include a check valve 15, typically 1¼ inches nominally, a water valve 16, typically ¾ inches nominally, 4 PVC elbows each of 45 degrees 17 and 90 degrees 18 of 1½, 1¼ and ¾ inches, 1 PVC union 19 each 1½, 1¼ and ¾ inches and 3 PVC couplings 20 each of 1½, 1¼ and ¾ inches.

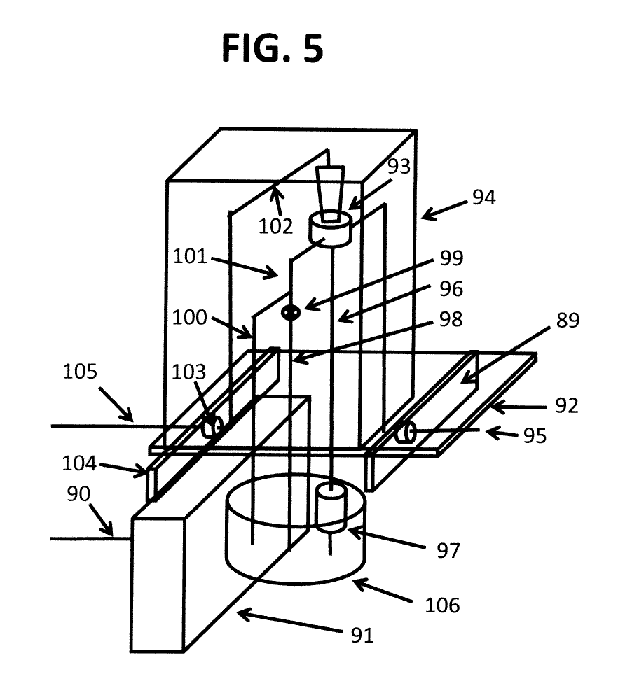

FIG. 5 is a Residential Crawlspace Back-Up Water Ejector Sump Pump Embodiment. For this embodiment the dimensional limit is the crawlspace and floor joist 2 height. The crawlspace is typically 18 inches to 5 feet high. The floor joists are typically 5.5 inches in vertical height. The grade 17 is typically 6 to 8 inches below top of the foundation 9 and the bottom of the floor joists. As such, considering the pipe diameter, the six-inch ordinance requirement is impossible to obtain if the water ejector potable valve is beneath the floor 1.

For this embodiment the water ejector 12 is located above the floor. Candidate locations include utility closets, cloth closets, a garage or any out of the way location. An enclosure box 18 with a door is used to provide security and prevent contact. The potable water inlet 3 enters through the crawlspace and rises through the floor to the water ejector typically 2 feet above the floor. The actuator rod 4 does not need a directional changer and extends vertically to the sump where the float 7 is situated. The inlet riser pipe 5 containing a check valve 10. The drainpipe 6 extends from the sump to connect with the inlet pipe 11. The discharge pipe 13 extends from the water ejector discharge port horizontally and downward vertically through the hole 16 in the exterior floor joist 14 out to the exterior 15 to create the minimum height air gap from the water ejector valve. This allows complete draining of the non-potable liquid upon the deactivation of the water ejector.

The remaining piping arrangement follows the same configuration and operation of the General Embodiment or the Energy Efficiency Embodiment. The potable water supply 3 is routed to the water inlet valve in the water ejector 12. The water ejector float actuator rod 4 extends downward to the actuator float 7 in the sump vessel 8 recessed in the basement floor.

As before a transparent pipe is used as the inlet pipe and the discharge pipe. This provides for a visual inspection and the conclusion that an air gap has been created.

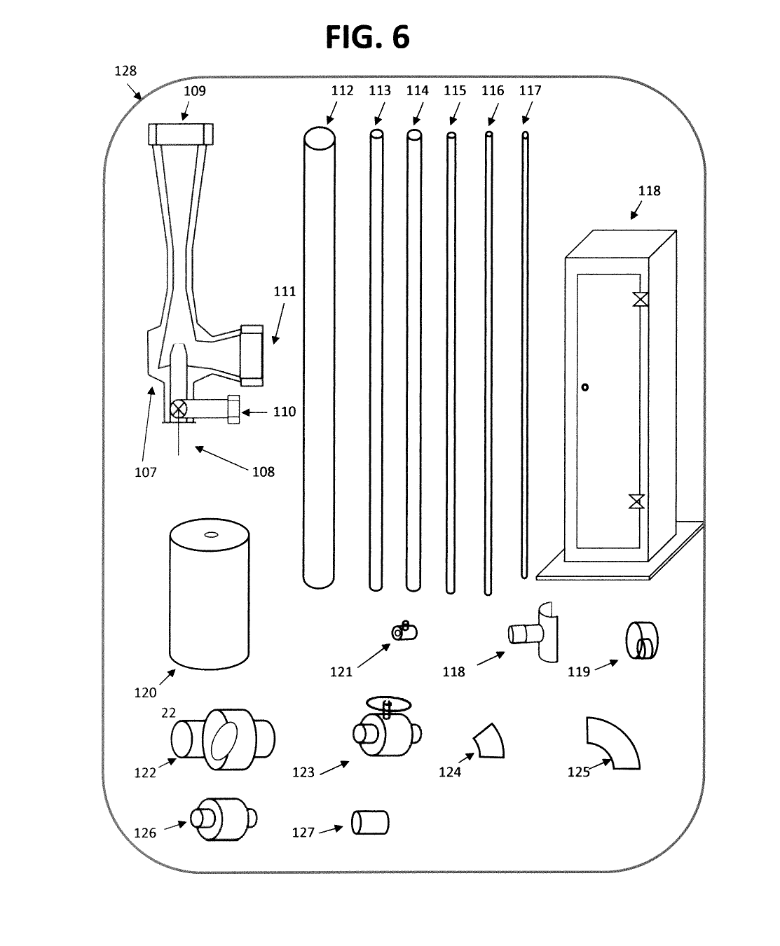

FIG. 6 shows a kit for a Residential Crawlspace Back-Up Water Ejector Sump Pump 23. The kit contents are the water ejector 1 with a potable water actuator rod 2, a discharge port 3, a potable water inlet 4 and an inlet port 5. The piping needs consist of the transparent discharge piping 6, typically clear PVC plastic pipe 1½ inches in nominal inside diameter, the transparent inlet piping 7, typically clear PVC plastic pipe 1¼ inches in nominal inside diameter, the opaque discharge piping 8, typically opaque PVC plastic pipe 1½ inches in nominal inside diameter, the opaque inlet and riser piping 9, typically opaque PVC plastic pipe 1¼ inches in nominal inside diameter, the opaque drain piping 10, typically opaque PVC plastic pipe ¾ inches in nominal inside diameter. One 5-foot length of each is provided. Also shown is an actuator rod 11, typically ¼ inches in diameter. Two 4-foot lengths with connectors are provided. The actuator rod and the drainpipe are provided lateral support by guides 13 held to the riser pipe by 1½ inch hose clamps 14. The actuator float 22 slides onto the bottom of the actuator rod and is held in place by 2 float actuator retainer rings 21. Various necessary pipe fittings include a check valve 15, typically 1¼ inches nominally, a water shut off valve 16, typically ¾ inches nominally, 4 PVC elbows each of 45 degrees 17 and 90 degrees 18 of 1½, 1¼ and ¾ inches, 1 PVC union 19 each of 1½, 1¼ and ¾ inches and 3 PVC couplings 20 each of 1½, 1¼ and ¾ inches. The above floor equipment is housed in an enclosure 12.

While I have shown and described the preferred embodiments of my invention, it will be understood that the invention may be embodied otherwise than as herein specifically illustrated or described, and that certain changes in form and arrangement of parts and the specific manner of practicing the invention may be made within the underlying idea or principles of the invention.

Although a very narrow claim is presented herein, it should be recognized that the scope of this invention is much broader than presented by such claims. It is intended that broader claims will be submitted in an application that claims the benefit of priority from this application. Insofar as the description above and the accompanying drawings disclose any additional subject matter that is not within the scope of the claims, the inventions are not dedicated to the public and the right to file one or more applications to claim such additional inventions is reserved.

What is claimed is:

1. A water ejector apparatus and a process with steps for transferring liquids from one location to another location with a piping arrangement comprising:
a vent pipe or opening to the atmosphere that allows the discharge piping which is at the same elevation to bleed dry of non-potable liquid and allows air to be drawn into the discharge piping and the water ejector;
an inlet piping, completely unobstructed, acting as a drain pipe, allowing the air drawn into the discharge piping and water ejector which allows non-potable liquid to drain from the water ejector potable water valve and inlet piping downward into the sump;
an airway in the discharge piping and water ejector, allowing the non-potable liquid to drain through the inlet piping back to the sump; and
an inlet pipe equipped with a drain and a discharge pipe equipped with a vent, creating an air gap between the potable water valve and the non-potable liquid thereby providing a safe cross connection between the non-potable liquid and the potable water source.

2. The water ejector apparatus according to claim 1 wherein the piping arrangement satisfies the backflow prevention plumbing codes of federal and local state agencies of a minimum vertical air gap distance of 6 inches for a safe cross connection.

3. The water ejector apparatus according to claim 1 wherein the inlet and discharge piping are partially or entirely constructed of a transparent material that satisfies the plumbing codes of federal and local state agencies by supplying a means of inspecting and testing by visual determination to ensure continued safe and secure cross connection operation.

4. The water ejector apparatus according to claim 1 wherein the inlet extends downward the minimum vertical air gap distance and wherein the inlet is divided into a riser pipe with a check valve to retain non-potable liquid and a smaller completely open drainpipe.

5. The water ejector apparatus according to claim 1 that details a kit for a residential full basement water ejector sump pump.

6. The water ejector apparatus according to claim 1 that details a kit for a residential crawlspace water ejector sump pump.

7. The water ejector apparatus according to claim 1 which only needs a simple float device and water supply control valve and no other moving parts which provides a maximum of reliability to a sump back-up system;
